(19) United States
(12) Patent Application Publication
(10) Pub. No.: US 2017/0095992 A1
(43) Pub. Date: Apr. 6, 2017

(54) DRAINAGE LINER WITH INTEGRAL DRAINAGE FEATURE AND GEOMEMBRANES INCLUDING SAME

(71) Applicant: Intertape Polymer Corp., Sarasota, FL (US)

(72) Inventors: Trevor Arthurs, Truro (CA); Sherryl Patton, Brookfield (CA); Boris Gourichon, Hilden (CA)

(21) Appl. No.: 15/285,960

(22) Filed: Oct. 5, 2016

Related U.S. Application Data
(60) Provisional application No. 62/237,246, filed on Oct. 5, 2015.

(51) Int. Cl. B32B 5/02; E02D 31/00; D03D 9/00; B32B 27/12; B32B 27/32

(52) U.S. Cl. CPC B32B 5/028; B32B 5/024; B32B 27/12; B32B 27/32; D03D 9/00; E02D 31/002; B32B 2262/0253; B32B 2307/7265; D03D 2700/0133; D03D 2700/0185; D10B 2321/0211; D10B 2505/204; E02D 2300/0078

(57) ABSTRACT

Drainage liners and geomembranes including the drainage liners are disclosed herein. The drainage liners have a woven scrim made of warp tapes and weft tapes, and have a plurality of high-denier strands each superimposed upon a warp tape or each superimposed upon a weft tape and each interwoven into the woven scrim by oppositely oriented tapes. The warp tapes or the weft tapes with superimposed high-denier strands thereon are spaced apart within the woven scrim by at least one tape of a same orientation, thereby defining a plurality of parallel channels for fluid flow between nearest neighboring high-denier strands.

### RELATED APPLICATIONS

This application claims the benefit of U.S. Provisional Application 62/237,246, filed Oct. 5, 2015, which is incorporated herein by reference.

### TECHNICAL FIELD

The subject matter relates generally to geomembrane systems for protecting against the release of contaminated liquids into the environment, in particular drainage liners having a geometry that provides unidirectional flow of liquids to a collection well.

### BACKGROUND

Geomembrane systems used in liquid containment applications generally include a primary liner, a drainage plane, and a secondary liner, the secondary liner being a backup in the event of leakage through the primary liner. Leakage through the primary liner could be caused by damage to the liner or installation defects. In order to determine that the primary liner has failed, resulting in a leak, geomembrane systems often have a drainage plane positioned between the primary and secondary liners that allows fluid to move towards one or more monitoring wells. Existing drainage planes have been made from heavy nonwoven geotextiles that permit fluid to flow uniformly in all directions. Other drainage planes have been made from expensive wick drain materials that allow the fluid to move in a predetermined linear direction. Wick drain materials are expensive and difficult to install in large geomembrane system applications.

Better, cheaper, easier to manufacture, and easier to install drainage plane solutions are needed.

### SUMMARY

In one aspect, drainage liners are disclosed herein that have overcome the problems discussed above and that are better, cheaper, easier to manufacture, and easier to install. The drainage liners have a woven scrim formed of a plurality of warp tapes and a plurality of weft tapes interwoven together, and a plurality of high-denier strands each superimposed upon a warp tape or each superimposed upon a weft tape and each interwoven into the woven scrim by oppositely oriented tapes. The warp tapes or the weft tapes with superimposed high-denier strands thereon are spaced apart within the woven scrim by at least one tape of a same orientation, thereby defining a plurality of parallel channels for fluid flow between nearest neighboring high-denier strands. The plurality of warp tapes and the plurality of weft tapes are woven together with generally no interstices therebetween. In one embodiment, the nearest neighboring high-denier strands are spaced apart a distance in a range of about 0.25 inches to about 3 inches.

The plurality of high-denier strands are multi-filament yarns. The high-denier strands have a denier of about 5000 to about 50,000. Each warp tape and each weft tape has a denier in a range of about 500 to about 3000.

In one aspect, the drainage liner includes a film layer applied to a second major surface opposite the first major surface, which includes the plurality of high-denier strands. The film layer may be a film layer laminated to the woven scrim, or it may be a film layer applied to the second major surface as a coating layer. Typically, the film layer comprises polyethylene, polypropylene, ethylene copolymers, propylene copolymers, polyvinyl chloride, and combinations thereof.

In another aspect, geomembranes are disclosed herein that include any of the drainage liners disclosed herein as a first liner. The geomembrane may include a second liner positioned above or below the first liner, and the first liner is positioned with the parallel channels oriented to direct fluid to a monitoring well or liquid collection apparatus.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of a drainage liner disclosed herein.

FIG. 2 is a top view of a woven scrim incorporated into the drainage liner of FIG. 1

FIG. 3 is a cross-section of the woven scrim of FIG. 2.

FIG. 4 is a schematic representation of a plan view of an apparatus used to fabricate the woven scrim of FIG. 2.

FIG. 5 is a side view of the apparatus of FIG. 4.

FIG. 6 is a cross-section of the drainage liner of FIG. 1.

FIG. 7 is a cross-section of one example of a panel seam coupling overlapping adjacent drainage liners together.

FIG. 8 is a cross-section of another example of a panel seam coupling adjacent drainage liners together.

FIG. 9 is a bottom perspective view of a panel that includes two sheets of the drainage liner of FIG. 1 coupled together at a seam.

FIG. 10 is a schematic representation of a front view of a testing apparatus for testing the hydraulic transmissivity of a drainage liner.

FIGS. 11A-C are top views of samples of the drainage liner of FIG. 1 tested for hydraulic transmissivity in the testing apparatus depicted in FIG. 10.

FIGS. 12A-C are side views of samples of the drainage liner of FIG. 1 tested for transmissivity in the testing apparatus depicted in FIG. 10.

FIG. 13 is a cross-section of another example of a woven scrim that can be incorporated into the drainage liner of FIG. 1.

### DESCRIPTION

Reference is now made in detail to the description of the embodiments as illustrated in the drawings and figures. While several embodiments are described in connection with these drawings, there is no intent to limit the disclosure to the embodiment or embodiments disclosed herein. On the contrary, the intent is to cover all alternatives, modifications, and equivalents.

Geomembranes and geotextiles used for preventing leakage of liquids into the ground generally include a primary liner and a secondary liner. If a breach occurs in the primary liner, liquid penetrates through the primary liner and is captured and prevented from further leakage by the secondary liner. The earlier such a leak is detected, the better. The geomembranes disclosed herein solve the problems of the prior systems discussed above, provide unidirectional flow for earlier leak detection, and are easier to install because the drainage feature is integral with the liner

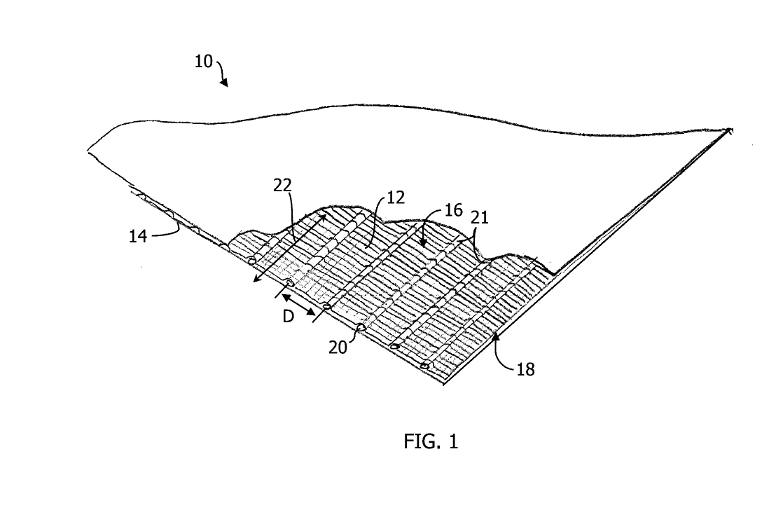

Referring to FIG. 1, a drainage liner, generally designated as reference number 10, is a liner with integral drainage features that include a woven scrim 12 having a first major surface 16, a second major surface 18, and a plurality of high-denier strands 20 woven into the woven scrim 12 at positions spaced apart by a distance D to define a plurality of parallel channels 22 therebetween. Each channel 22 is defined between nearest neighboring strands 21 of the high-denier strands 20. The drainage liner 10 includes at least one film 14 applied or attached to the second major surface 18 of the woven scrim 12. The film 14 is one that prevents fluid from penetrating through the drainage liner 10, i.e., is fluid impervious, and the plurality of parallel channels 22 direct fluid in a linear direction. The first major surface 16 is the side of the woven scrim 12 with the high-denier strands 20 defining the plurality of parallel channels 22. The second major surface 18 of the scrim 12 is the side opposite the first major surface 16. The drainage liner 10, thus, incorporates a drainage plane or drainage feature into the liner as a single sheet of material. When included in a geomembrane system as a secondary liner, positioned beneath a primary liner, the secondary liner 10 retains the fluid (prevents further leakage into the environment because of the presence of the film 14) and directs the fluid in one direction along the parallel channels 22 toward one or more monitoring wells or other collection/detection area.

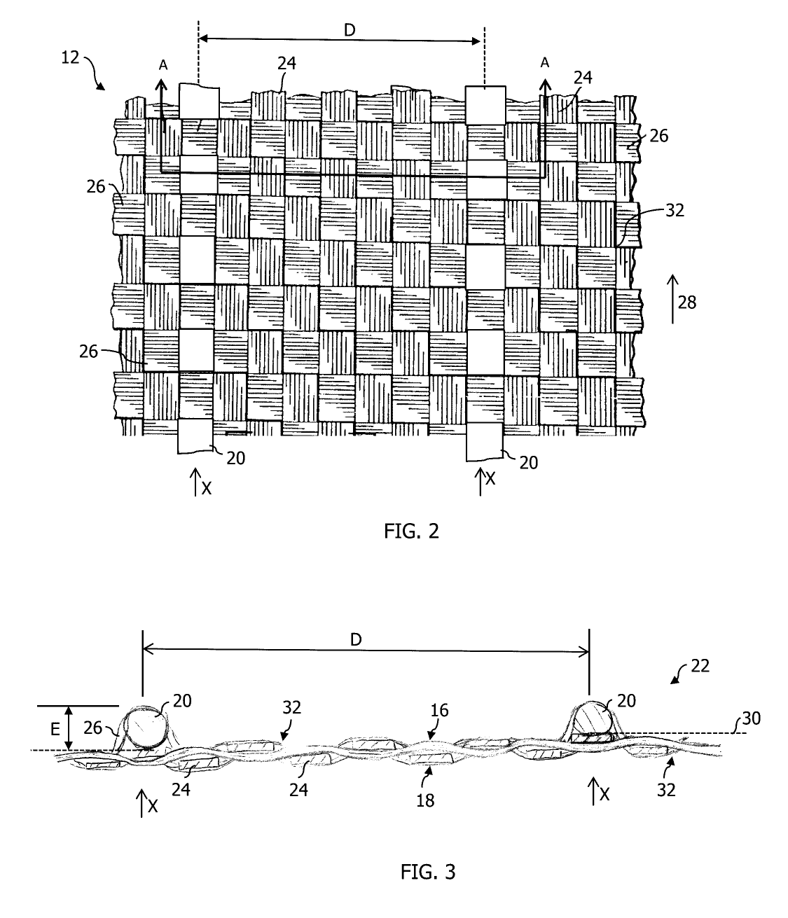

Referring to FIG. 2, the woven scrim 12 generally includes a plurality of warp tapes 24 interwoven with a plurality of weft tapes 26. The warp tapes 24 are in a side-by-side relationship with each other, and similarly, the weft tapes 26 are in a side-by-side relationship with each other. The warp tapes 24 are generally in a substantially parallel relationship with each other and with a machine direction 28, and the weft tapes 26 are in a substantially parallel relationship with each other and transverse to the machine direction 28. The tapes 24, 26, as shown, are typically woven together with generally no interstices 32 between the warp and weft tapes. The woven scrim 12 includes the plurality of high-denier strands 20 woven therein at periodic positions X in the weave pattern. The high-denier strands 20 can be woven in the warp or weft direction, but for ease of manufacturing, preferably woven in the machine direction 28. The high-denier strands 20 are spaced apart by a distance D, measured center-to-center, which is in a range of about 0.25 inches to about 3 inches, more preferably about 0.5 inches to about 3 inches, or if desired about 1 inch to about 2.5 inches. In one embodiment, the high-denier strands 20 are spaced apart by the distance D of about 1.5 inches.

FIG. 3 illustrates a cross-section of the woven scrim 12 taken along section line A-A in FIG. 2. The proportions in FIG. 3 are exaggerated for purposes of illustration. Each of the high-denier strands 20 is positioned on top of (superimposed on) one of the flat warp tapes 24 (or both on weft tapes 26, in another embodiment). Superimposing the high-denier strands 20 on top of the flat warp tapes 24 maximizes the degree to which the high-denier strands 20 protrude above a plane 30 of the weave, thereby defining the side walls of the channels 22 and increasing the depth E thereof. The plurality of parallel channels 22 increase the transmissivity of the drainage liner 10, which in turn allows leaked fluid penetrating through a primary liner positioned above the drainage liner 10 or the drainage liner 10 itself when used as a primary liner to flow more quickly to a monitoring well to provide faster warning of a breach. The transmissivity of the drainage liner 10 can be modified by altering the denier of the high-denier strands 20 or the positions X in the weave in which the high-denier strands 20 are woven.

As used herein, “warp tapes” and/or “weft tapes” means generally flat tape-like elongated strands made from a polymeric material, which typically have a width of about 0.1 cm to about 0.8 cm, or more preferably about 0.3 cm to about 0.5 cm. The warp and weft tapes 24, 26 are generally formed from polyolefin materials, examples of which include, but are not limited to, polyethylene, high density polyethylene (HDPE), low density polyethylene (LDPE), polypropylene, copolymers, other polyolefins, or combinations thereof. The tapes 24, 26 may also be formed from other thermoplastic materials, examples of which include polyethylene terephthalate, other polyesters, polyamides such as nylon, and combinations thereof In one aspect, the warp and weft tapes 24, 26 are HDPE or polypropylene tapes. The warp and weft tapes 24, 26 can include additives such as UV stabilizers, anti-oxidants, pigments, anticorrosion additives, or other additives. The warp and weft tapes 24, 26 can be oriented tapes, especially oriented tapes of polypropylene or HDPE. The warp and weft tapes 24, 26 may have a denier in a range of about 500 to about 3000, or more preferably from about 800 to about 2000. Tapes generally used to form scrim materials are commercially available or may be made by extrusion of a flat film of the material, cooling of the film material, for example in a water bath, and cutting or slitting the film material into individual tapes.

Although the woven scrim 12 is described above as being made from the plurality of warp tapes 24 interwoven with the plurality of weft tapes 26, the drainage liner 10 can include a woven or knitted scrim made from polyester or nylon multifilament strands having a plurality of high-denier strands 20 woven therein at periodic positions X in the weave pattern.

As shown in FIGS. 2-3, the warp tapes 24, weft tapes 26, and high-denier strands 20 (superimposed upon a subset of the flat warp tapes 24 or a subset of weft tapes 26 ) are woven together to form a woven scrim 12 with generally no interstices 32 between the warp and weft tapes 24, 26. Reducing or eliminating the interstices 32 in the woven scrim 12 provides a generally continuous substrate for application of the film 14 to the second major surface of the scrim and is a better leak resistant liner. Moreover, film 14 is not extruded through the woven scrim 12, which is preferred because film extruded through the scrim would mar the floor of the parallel channels 22 and likely create barriers or features that would interfere with the flow of fluid toward the monitoring wells or other leak detection means. The woven scrim 12 can have from about 4 to about 30 warp tapes per inch and from about 4 to about 30 weft tapes per inch. As shown in FIG. 14, the woven scrim 12 can have two or more warp tapes 24 and two or more weft tapes 26 at each position in the weave pattern. Woven scrims 12 having multiple tapes superimposed at each weave position are disclosed in U.S. Pat. No. 6,367,513, which is incorporated herein by reference in its entirety.

The plurality of high-denier strands 20 can be high-denier tapes, fibers, filaments, multi-filament yarns, or combinations thereof and can be made from polyolefins, such as polypropylene, HDPE, LDPE, or other polyolefins, for example. The high-denier strands 20 can also be made of polyamides such as nylon or polyesters, such as polyethylene terephthalate. The high-denier strands 20 can be multi-filament yarns that can be a polyethylene, polypropylene, polyamide, and/or polyester multi-filament yarn. The high-denier strands 20 can have a second denier that is greater than the first denier of the warp tapes 24 and weft tapes 26. The second denier of the high-denier strands 20 can be in a range of about 5000 to about 50,000, or from about 5000 to about 15,000 in another aspect, or about 9000 denier in yet another aspect. In another aspect, the high-denier strands 20 can be very high-denier strands having a denier greater than about 10,000.

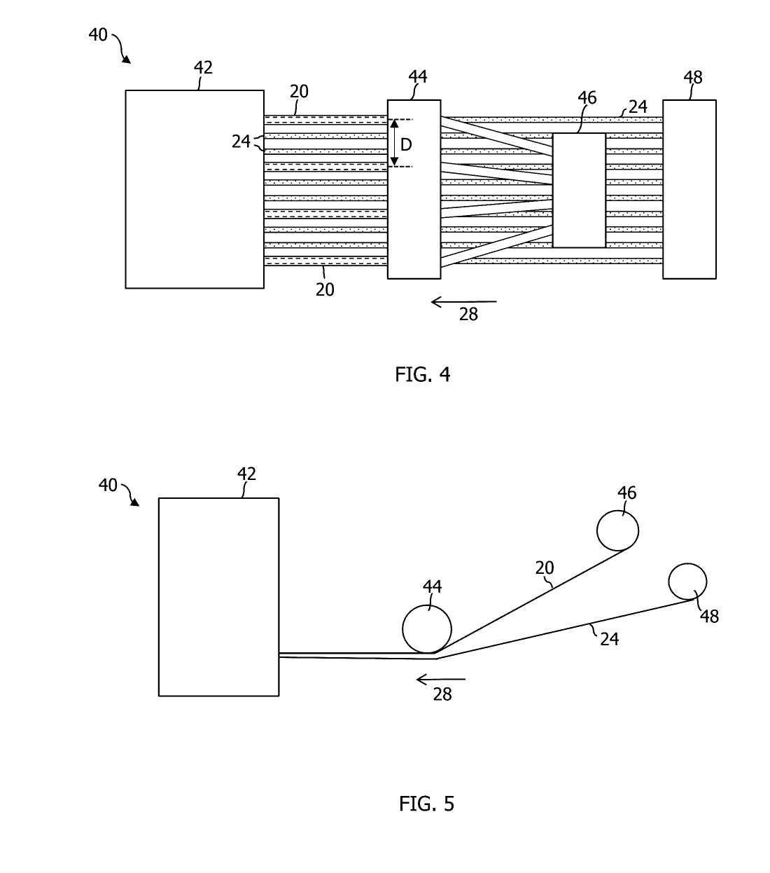

Referring now to FIG. 4, an apparatus 40 for fabrication of the woven scrim 12 (FIGS. 2 and 3) generally includes a loom 42, a guide roller 44, and two or more feed rolls 46, 48. One of the feed rolls 48 is a roll of slit warp tapes 24, which for clarity are shown in a spaced apart relationship in FIG. 4, but in practice would be a plurality of tapes in a side-by-side relationship. One or more other feed rolls 46 is a roll of the high-denier strands 20. The high-denier strands 20 may be spaced apart on the feed roll 46 or may be in a side-to-side relationship on the feed roll 46. In one aspect, each high-denier strand 20 may be fed from a separate feed roll 46. The warp tapes 24 and high-denier strands 20 are fed from the feed rolls 46, 48 and passed partially around the guide roller 44. The high-denier strands 20 are guided into a spaced apart relationship, in which each high-denier strand 20 is spaced apart from each adjacent high-denier strand 20 by the distance D. The high-denier strands 20 are superimposed on top of a subset of the warp tapes 24, which are shown in FIG. 4 by dashed lines to indicated that the warp tapes 24 are positioned underneath the high-denier strands 20, at spaced apart positions X (FIGS. 2 and 3) in the weave. The warp tapes 24 and high-denier strands 20 superimposed on top of warp tapes 24 are fed into the loom 42.

FIG. 5 shows the feed rolls 46, 48 in a spaced apart relationship, with the warp tapes 24 and high-denier strands 20 being fed therefrom. The warp tapes 24 and high-denier strands 20 superimposed on top of warp tapes 24 pass around the guide roller 44 and are fed to the loom 42. In the loom 42, the warp tapes 24 and high-denier strands 20 superimposed on top of warp tapes 24 are woven with the weft tapes 26 by techniques known in the art.

In one embodiment, a beam of warp tapes 24 is assembled on feed roll 48. Rather than being fed from feed roll 46, the high-denier strands 20 are fed from a plurality of packages or spools (not shown) that are assembled onto a creel (not shown), which positions each high-denier strand 20 at the correct weave position X (FIGS. 2 and 3) as it is unwound from the package or spool and feeds the high-denier strands 20 to the loom 42.

FIGS. 4 and 5 show only the warp tapes 24 being fed to the loom 42; however, it is understood by one of ordinary skill in the art that the weft tapes 26 (FIG. 3) are also fed to the loom 42. In one embodiment, the high-denier strands 20 may be oriented in the weft direction and be superimposed over top of a subset of weft tapes 26. At designated positions in the weave pattern, the high-denier strands 20 may be superimposed over top of the weft tapes 26 by feeding a first pass of the weft tape 26 and then feeding a second pass of the high-denier strand 20 through the loom 42 prior to alternating the harness frames (not shown) in the weaving process.

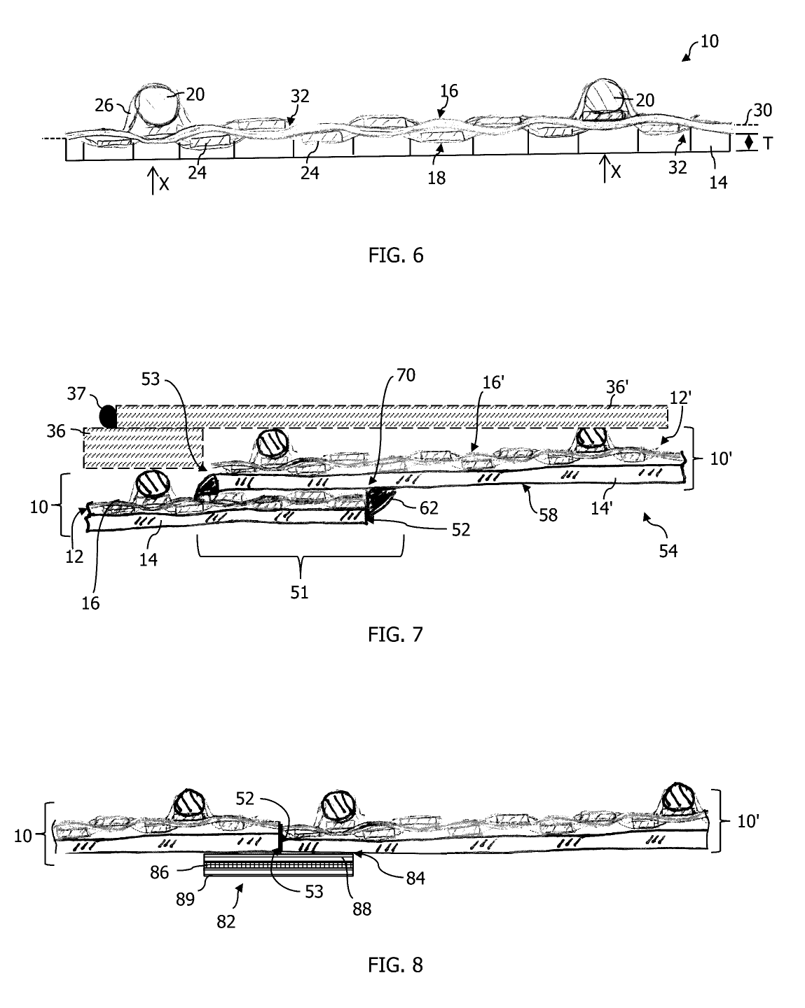

Referring now to FIG. 6, a film 14 is applied directly to the second major surface 18 of the woven scrim 12. The film 14 is typically a fluid impermeable film that provides a barrier against penetration of fluids therethrough. The film 14 may be a polyolefin film, such as polypropylene, HDPE, LDPE, or other polyolefinic films, for example. In one aspect, the film 14 can be a blend of polypropylene and HDPE or LDPE. The film 14 can also be made from one or more of ethylvinyl acetate (EVA), ethyl methacrylate (EMA), linear low density polyethylene (LLDPE), polypropylene (PP) copolymer, ethylene copolymer, polyvinyl chloride (PVC), or chlorosulfonated polyethylene (CSPE). The film 14 can also include additives, such as anti-oxidants, pigments, UV stabilizers, or other additives to provide modified characteristics to the drainage liner 10. The film 14 can be applied to the woven scrim 12 by extrusion coating or extrusion laminating. The film 14 can have a thickness T in a range from about 1 mil to about 20 mil, or in a range from about 2 mil to about 10 mil in another aspect, or about 5.5 mil in yet another embodiment.

The film 14 can include multiple layers (not shown) of film materials extrusion coated or extrusion laminated together and to the woven scrim 12. The film 14 may also include a tie layer (not shown) to tie the film 14 to the woven scrim 12.

Referring now to FIG. 7, one option for coupling separate drainage liners into a panel is shown. The first drainage liner 10 is coupled to a second drainage liner 10′ by overlapping the second edge 53 of the second drainage liner 10′ with the first edge 52 of the first drainage liner 10 and securing the drainage liner 10 to the adjacent drainage liner 10′. Here, the drainage liner 10′ is positioned to overlap drainage liner 10 so that the first major surface 16 of the woven scrim 12 of the first drainage liner 10 faces the outer surface 58 of the film 14′ of the second drainage liner 10′. The first major surface 16 of the woven scrim 12 of the drainage liner 10 can be secured to the outer surface 58 of film 14′ by welding, heat-sealing, adhering with an adhesive, bonding with an extruded film or bead, other securing methods, or combinations thereof. An interface 70 between the woven scrim 12 of the first drainage liner 10 and the outer surface 58 of the film 14′ of the second drainage liner 10′ is further sealed with one or more extrusion beads 62 or other seals. In FIG. 7, a first extrusion bead 62 is positioned at the second edge 53 of the second drainage liner 10′ and a second extrusion bead 62 is positioned at interface 70 at the first edge 52 of the first drainage liner 10.

The panel 54 of FIG. 7 optionally includes one or more second films 36, 36′ applied to or overlaying the first major surfaces 16, 16′ of the woven scrims 12, 12′ as a separate primary liner or as an integral primary liner. The second films 36, 36′ may overlap and form a seam to provide a panel large enough to cover the underlying panel 54. The overlapping portions of the first and second films 36, 36′ may be secured to one another by welding, heat-sealing, adhering with an adhesive, bonding with an extruded film or bead, other securing methods, or combinations thereof, and may include a seal bead 37 at an interface of mating films.

Referring to FIG. 8, a second option for coupling separate drainage liners 10, 10′ into a panel is shown. The first edge 52 of the first drainage liner 10 is placed in a flush abutted relationship to the second edge 53 of the second drainage liner 10′ and a two-side coated woven strip or fiber strip 82 is placed under the mated edges 52, 53 and is welded thereto to form a weld 84 resulting in a water-tight seal. While a two-sided coated strip is shown, it may alternately be a one-side coated strip. The strip 82 includes a substrate 86, which may be a woven material, fiber material, nonwoven material, or the like, even including a scrim type configuration, and includes a top coated layer 88 and a bottom coated layer 89, the bottom coated layer 89 being optional.

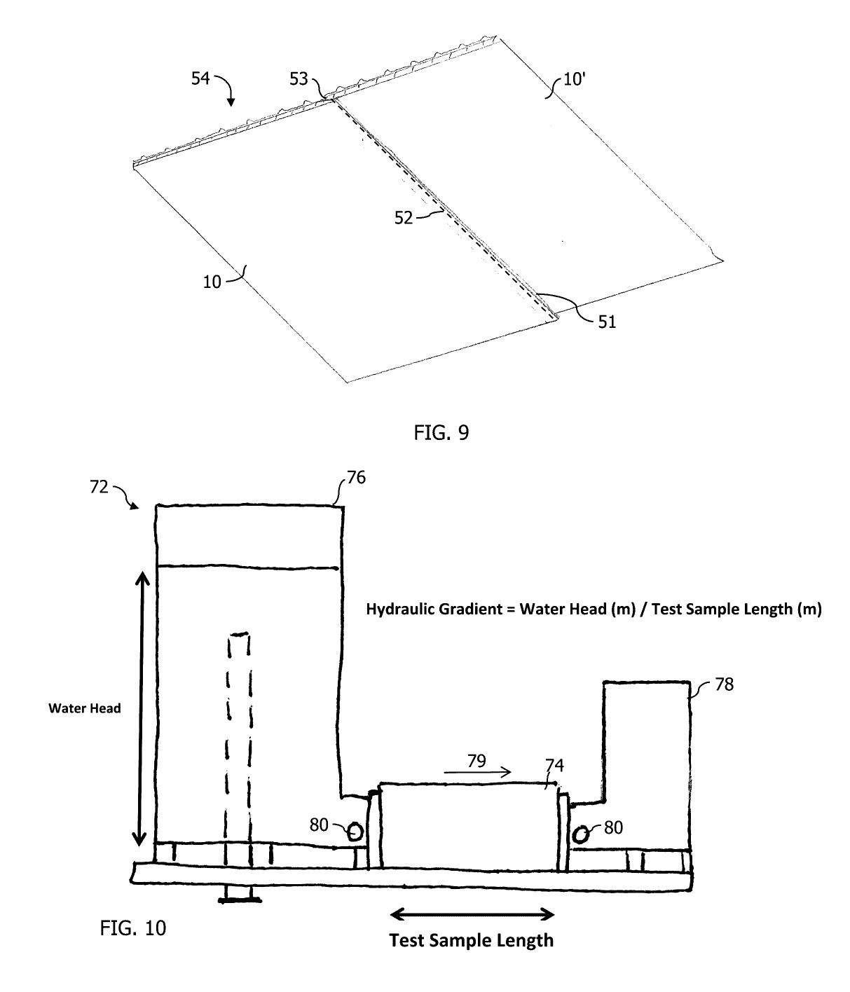

Referring to FIG. 9, a panel 54 is illustrated having a drainage liner 10 coupled to at least one adjacent drainage liner 10′ at a seam 51. FIG. 10 shows the underside of the panel 54. The first edge 52 of the first drainage liner 10 is shown as a dashed line to indicate that it overlaps the second edge 53 of the second drainage liner 10′ and is therefore behind the first edge 52 of the drainage liner 10.

A method for detecting a leak in a primary liner of a geomembrane system includes providing a primary liner that is impermeable to liquids and providing a drainage liner 10 according to the present disclosure. The drainage liner 10 is first installed in an area for which liquid containment is desired and oriented with the channels 22 formed by the high-denier strands 20 woven into the scrim 12 directing fluid toward a monitoring well or other liquid collection apparatus. In this configuration, the channels 22 are facing upwards. The area to be contained may be graded prior to installing the drainage liner 10 so that liquid penetrating through the primary liner flows by gravity along the channels 22 to the monitoring well(s). The primary liner is installed over top of the drainage liner 10. In one embodiment, the drainage liner 10 has a secondary film applied to the second major surface 18 of the scrim 12, the secondary film providing the primary liner portion of the geomembrane system. When a failure occurs in the primary liner, liquid flows into the plurality of channels 22 defined by the woven scrim 12. The film 14 applied to the first major surface 16 of the scrim 12 prevents further leakage of the liquid through the geomembrane system. The channels 22 direct the liquid unidirectionally towards a monitoring well, where the liquid flow is detected to indicate that a leak has occurred in the primary liner.

In another method of detecting a leak in a geomembrane system, the film 14 of the drainage liner 10 is proximate the contained fluid source such that the drainage liner 10 acts as the primary liner. A secondary liner is first installed in the area for which liquid containment is desired. Once the secondary liner is installed, a sheet or panel of the drainage liner 10 is installed over the secondary liner with the woven scrim 12 and the channels 22 formed by the plurality of high-denier strands 20 facing downward towards the secondary liner. The drainage liner 10 is oriented with the channels 22 directing fluid toward the monitoring well or other liquid collection apparatus. The film 14 of the drainage liner 10 provides the primary liner of the geomembrane system. When a leak occurs in the film 14 of the drainage liner 10, liquid flows into the plurality of channels 22 defined by the woven scrim 12. The secondary liner prevents further leakage of the liquid through the geomembrane system. The channels 22 direct the liquid unidirectionally towards the monitoring well, where the liquid flow is detected to indicate that a leak has occurred in the film 14 of the drainage liner 10. The secondary liner may be integral with the drainage liner 10, as shown in FIG. 7 if it is flipped upside down.

### WORKING EXAMPLES

A scrim was woven from warp and weft tapes 24, 26. The warp tapes 24 were HDPE tapes having a denier of 1600 and a width of about 0.125 inches (0.32 cm). The weft tapes 26 were HDPE tapes having a denier of 1550 and a width of 0.170 inches (0.43 cm). The warp tapes 24 and the weft tapes 26 were both woven in at 16 tapes per inch. The warp and weft tapes 24, 26 were stacked in both directions so that the 16×16 count appears to be an 8×8 count (as shown in FIG. 13). A plurality of high-denier multi-filament yarns were added in the warp direction and spaced apart. The weave pattern included 16 warp tapes per inch and 16 weft tapes per inch. One 9000 denier multi-filament yarn was woven into the scrim at positions placed on top of an existing pair of tapes in the warp direction every 1.5 inches. The scrim was tightly woven to minimize interstices in the scrim. A 5.5 mil black LLDPE/PE film was extrusion laminated to the major surface of the woven scrim opposite the side with the high denier multi-filament yarns, and the second major surface of the woven scrim having the high denier multi-filament yarns was left uncoated. Multiple samples of the resulting drainage liner 10 were tested for mass per unit area, nominal thickness, core thickness, ply adhesion, tensile strength, rod puncture, trapezoidal tear (machine direction and cross-machine direction), and grab breaking load and elongation (machine direction and cross-machine direction). The test methods listed in Table 1 are incorporated herein by reference in their entirety. The test data in Table 1 was obtained for the drainage liner 10.

TABLE 1

| | | Average | Standard |
|---|---|---|---|
| Property | Test Method | Value | Deviation |
| Mass per unit area (g/m³) | ASTM D 5261 | 516.3 | 8.9 |
| Nominal thickness (mm) | ASTM D 5199 | 1.50 | 0.07 |
| Core thickness (mm) | ASTM D 5994 | 0.53 | 0.03 |
| Ply adhesion (N/cm) | Modified | 120.5 | 17.9 |
| | ASTM D 751 | | |
| Tensile properties - wide strip | Modified | 28424 | 2635 |
| method (N/m) | ASTM D 4595 | | |
| Rod puncture (N) | ASTM D 4833 | 383.5 | 39.2 |
| Trapezoidal tear - machine (N) | ASTM D 4533 | 120.5 | 18.0 |
| Trapezoidal tear - cross machine | ASTM D 4533 | 467.2 | 55.9 |
| (N) | | | |
| Grab breaking load - machine | ASTM D 4632 | 1276.0 | 42.7 |
| (N) | | | |
| Elongation - machine (%) | ASTM D 4632 | 17.63 | 0.54 |
| Grab breaking load - cross | ASTM D 4632 | 740.6 | 41.7 |
| machine (N) | | | |
| Elongation - cross machine (%) | ASTM D 4632 | 16.86 | 0.5 |

Samples of the drainage liner 10 were also tested for hydraulic transmissivity using the testing apparatus 72 illustrated in FIG. 10. The samples of the drainage liner 10 were placed in the base 74 portion of the apparatus 72 and a liquid was passed through the sample drainage liner 10 from the reservoir box 76 to the outflow weir 78. The direction of flow 79 is indicated by an arrow pointing from the reservoir box 76 to the outflow weir 78. The samples of the drainage liner 10 were tested for hydraulic transmissivity according to ASTM D 4716, which is incorporated herein by reference in its entirety. The testing apparatus 72 includes manometer taps 80. The hydraulic gradient is determined according to the formula: water head (m)/test sample length (m).

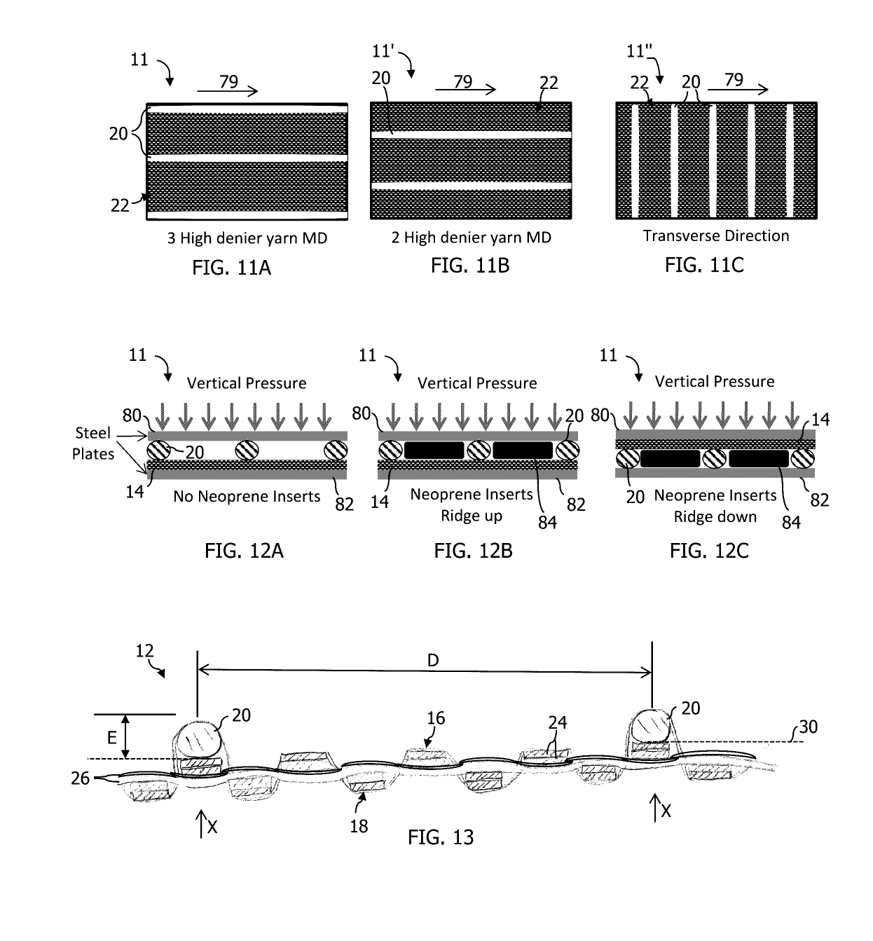

Referring to FIGS. 11A-11C, samples 11, 11′, 11″ having various configurations were prepared from the drainage liner 10 prepared above. Referring to FIG. 11A, a first group of samples 11 of the drainage liner 10 was cut so that each sample had three high-denier yarns 20 extending substantially parallel to the direction of fluid flow through the testing apparatus 72. Referring to FIGS. 12A-12C, the samples 11 of the drainage liner 10 of the first group were tested in each of three configurations. Referring to FIG. 12A, in the first configuration, the samples 11 were placed between a first steel plate 80 and a second steel plate 82 with the high-denier yarns 20 and channels 22 facing up towards the first steel plate 80. In a second configuration as shown in FIG. 12B, neoprene inserts 84 were placed in the channels 22 defined by the samples 11, and the samples 11 with the neoprene inserts 84 were then placed between the first steel plate 80 and the second steel plate 82. In the second configuration, the samples 11 were oriented with the high-denier yarns 20 facing up towards the first steel plate 80. In a third configuration as shown in FIG. 12C, the samples 11 with the neoprene inserts 84 added were placed between the first steel plate 80 and the second steel plate 82 with the high-denier yarns 20 facing down towards the second steel plate 82. For each configuration, vertical pressure was applied downward to the second steel plate at 1.4, 5, 8, and 11 psi in each of four samples. The hydraulic gradient remained constant across all samples. Hydraulic transmissivity test data for the first group of samples 11 of the drainage liner 10 are provided in Table 2 below.

TABLE 2
Hydraulic Transmissivity (10⁻³ m²/s) - First Group of Samples 11 -
3 high-denier yarns oriented in the machine direction substantially
parallel to the direction of fluid flow through the testing apparatus

| | | | | |
|---|---|---|---|---|
| Hydraulic Gradient | 1 | 1 | 1 | 1 |
| Vertical Pressure (psi) | 1.4 | 5 | 8 | 11 |
| Configuration 1 (FIG. 12A) | 0.1914 | 0.1236 | 0.0994 | 0.0760 |
| (10⁻³ m²/s) | | | | |
| Configuration 1 (FIG. 12A) | 0.1944 | 0.1395 | 0.1025 | 0.0886 |
| (10⁻³ m²/s) | | | | |
| Configuration 1 (FIG. 12A) | 0.2066 | 0.1303 | 0.1014 | 0.0852 |
| (10⁻³ m²/s) | | | | |
| Configuration 2 (FIG. 12B) | 0.0146 | 0.0094 | 0.0070 | 0.0035 |
| (10⁻³ m²/s) | | | | |
| Configuration 2 (FIG. 12B) | 0.0083 | 0.0060 | 0.0044 | 0.0035 |
| (10⁻³ m²/s) | | | | |
| Configuration 3 (FIG. 12C) | 0.0515 | 0.0130 | 0.0074 | 0.0049 |
| (10⁻³ m²/s) | | | | |
| Configuration 3 (FIG. 12C) | 0.0251 | 0.0070 | 0.0039 | 0.0024 |
| (10⁻³ m²/s) | | | | |

Referring to FIG. 11B, a second group of samples 11′ of the drainage liner 10 was prepared so that each sample 11′ had two high-denier yarns 20 extending substantially parallel to the direction of flow 79 through the testing apparatus 72. The samples 11′ of the second group were testing using the configuration shown in FIGS. 12A-12C. Vertical pressure was applied downward to the second steel plate at 1.4, 5, 8, and 11 psi in each of four sets of three samples. One additional sample was tested for hydraulic transmissivity with a vertical pressure of 2.8 psi, and another sample was tested at a vertical pressure of 69.5 psi. Another sample was tested at a vertical pressure of 1.4 psi and a hydraulic gradient of 0.1. Hydraulic transmissivity test data for the second group of samples 11′ of the drainage liner 10 are provided in Table 3 below.

TABLE 3
Hydraulic Transmissivity (10⁻³ m²/s) - Second Group of Samples 11′ -
2 high-denier yarns oriented in the machine direction substantially parallel
to the direction of fluid flow through the testing apparatus

| | | | | | | | |
|---|---|---|---|---|---|---|---|
| Hydraulic Gradient | 1 | 1 | 1 | 1 | 1 | 1 | 0.1 |
| Vertical Pressure (psi) | 1.4 | 2.8 | 5 | 8 | 11 | 69.5 | 1.4 |
| Config. 1 (FIG. 12A) | 0.1606 | 0.1100 | 0.1050 | 0.0793 | 0.0670 | 0.0090 | 0.6900 |
| (10⁻³ m²/s) | | | | | | | |
| Config. 1 (FIG. 12A) | 0.1734 | N/A | 0.1185 | 0.9216 | 0.7466 | N/A | N/A |
| (10⁻³ m²/s) | | | | | | | |
| Config. 1 (FIG. 12A) | 0.1843 | N/A | 0.1329 | 0.1067 | 0.0890 | N/A | N/A |
| (10⁻³ m²/s) | | | | | | | |

Referring to FIG. 11C, a third group of samples 11″ of the drainage liner 10 was prepared so that each sample 11″ had a plurality of high-denier yarns 20 extending in a direction transverse to the direction of flow 79 through the testing apparatus 72. The samples 11″ of the third group were testing using the configuration shown in FIGS. 12A- 12 C and described above. Samples were tested for hydraulic transmissivity with vertical pressures of 1.4, 2.8, 5, 8, 11, and 69.5 psi on the first steel plate 80. One additional sample was tested for hydraulic transmissivity with a vertical pressure of 1.4 psi and a hydraulic gradient of 0.1. Hydraulic transmissivity test data for the third group of samples 11″ of the drainage liner 10 are provided in Table 4 below. The hydraulic transmissivity of test samples having high-denier yarns 20 positioned transverse to the direction of flow 79 through testing apparatus 72 is substantially less than for samples having the high-denier yarns 20 oriented generally parallel to the direction of flow 79. The lower transmissivity of the cross-flow orientation indicates that the drainage liners 10 disclosed herein direct the flow of liquids in a single direction and inhibit flow of liquids between channels 22. These results show the unidirectional flow characteristics of the drainage liners 10 disclosed herein.

TABLE 4
Hydraulic Transmissivity (10⁻³ m²/s) - Third Group of Samples 11″ - 2
high-denier yarns oriented transverse to the fluid flow through the testing apparatus

| | | | | | | | |
|---|---|---|---|---|---|---|---|
| Hydraulic Gradient | 1 | 1 | 1 | 1 | 1 | 1 | 0.1 |
| Vertical Pressure (psi) | 1.4 | 2.8 | 5 | 8 | 11 | 69.5 | 1.4 |
| Config. 1 (FIG. 12A) | 0.007 | 0.06 | 0.006 | 0.0052 | 0.0045 | 0.0097 | 0.1200 |
| (10⁻³ m²/s) | | | | | | | |
| Config. 1 (FIG. 12A) | 0.0025 | N/A | 0.0013 | 0.0010 | 0.0008 | N/A | N/A |
| (10⁻³ m²/s) | | | | | | | |

The drainage liners 10 disclosed herein provide a unidirectional flow media incorporated into a liner that can be used in conjunction with a geomembrane system. The drainage liners 10 disclosed herein can be installed as a secondary liner to capture liquid leaking through the primary liner and direct the liquid towards a monitoring well. The drainage liners 10 can also be installed as a primary liner with the woven scrim 12 and the channels 22 defined by the high-denier strands 20 facing down towards a secondary liner installed underneath. Drainage liners having the film secured to both major surfaces of the woven scrim, as described herein, can be employed as a single liner incorporating both the primary liner and the secondary liner with the woven scrim positioned therebetween. The drainage liners 10 provide a unidirectional flow liner at a lower cost than other geotextile products, which significantly reduces the costs of installing a geomembrane system. The drainage liners 10 provide linear liquid flow in one direction at a high transmissivity rate, which allows leaking fluid to reach a monitoring well or other collection device more quickly so that leaks in a primary liner can be detected and repaired. Drainage liners 10 disclosed herein are easy to assemble together into larger panels for larger installations, among other benefits.

Although the invention is shown and described with respect to certain embodiments, it is obvious that modifications will occur to those skilled in the art upon reading and understanding the specification, and the present invention includes all such modifications.

What is claimed is:

1. A drainage liner comprising:
a woven scrim having a first major surface and an opposing second major surface, the woven scrim comprising:
a plurality of warp tapes and a plurality of weft tapes woven together; and
a plurality of high-denier strands each superimposed upon a warp tape or each superimposed upon a weft tape that form the first major surface and each interwoven with the woven scrim by oppositely oriented tapes;
wherein the warp tapes or the weft tapes with superimposed high-denier strands thereon are spaced apart within the woven scrim by at least one tape of a same orientation, thereby defining a plurality of parallel channels for fluid flow between nearest neighboring high-denier strands.

2. The drainage liner of claim 1, further comprising a film layer applied to the second major surface.

3. The drainage liner of claim 2, wherein the film layer is a film layer laminated to the woven scrim or is a film layer applied to the second major surface as a coating layer.

4. The drainage liner of claim 2, wherein the film layer comprises polyethylene, polypropylene, ethylene copolymers, propylene copolymers, polyvinyl chloride, and combinations thereof.

5. The drainage liner of claim 1, wherein the plurality of high-denier strands are multi-filament yarns.

6. The drainage liner of claim 5, wherein the high-denier strands have a denier of about 5000 to about 50,000.

7. The drainage liner of claim 5, wherein each warp tape and each weft tape has a denier in a range of about 500 to about 3000.

8. The drainage liner of claim 1, wherein the plurality of warp tapes and the plurality of weft tapes are woven together with generally no interstices therebetween.

9. The drainage liner of claim 1, wherein the nearest neighboring high-denier strands are spaced apart a distance in a range of about 0.25 inches to about 3 inches.

10. A geomembrane comprising:
a first drainage liner comprising:
a woven scrim having a first major surface and an opposing second major surface, the woven scrim comprising:
a plurality of warp tapes and a plurality of weft tapes woven together; and
a plurality of high-denier strands each superimposed upon a warp tape or each superimposed upon a weft tape that form the first major surface and each interwoven with the woven scrim by oppositely oriented tapes;
wherein the warp tapes or the weft tapes with superimposed high-denier strands thereon are spaced apart within the woven scrim by at least one tape of a same orientation, thereby defining a plurality of parallel channels for fluid flow between nearest neighboring high-denier strands.

11. The geomembrane of claim 10, further comprising a second liner above or below the first liner, wherein the first liner is positioned with the parallel channels oriented to direct fluid to a monitoring well or liquid collection apparatus.

12. The geomembrane of claim 10, further comprising a film layer applied to the second major surface.

13. The geomembrane of claim 12, wherein the film layer is a film layer laminated to the woven scrim or is a film layer applied to the second major surface as a coating layer.

14. The geomembrane of claim 12, wherein the film layer comprises polyethylene, polypropylene, ethylene copolymers, propylene copolymers, polyvinyl chloride, and combinations thereof.

15. The geomembrane of claim 10, wherein the plurality of high-denier strands are multi-filament yarns.

16. The geomembrane of claim 15, wherein the high-denier strands have a denier of about 5000 to about 50,000.

17. The geomembrane of claim 15, wherein each warp tape and each weft tape has a denier in a range of about 500 to about 3000.

18. The geomembrane of claim 10, wherein the plurality of warp tapes and the plurality of weft tapes are woven together with generally no interstices therebetween.

19. The geomembrane of claim 10, wherein the nearest neighboring high-denier strands are spaced apart a distance in a range of about 0.25 inches to about 3 inches.
